(19) United States
(12) Patent Application Publication
(10) Pub. No.: US 2016/0281995 A1
(43) Pub. Date: Sep. 29, 2016

(54) Safety Alert Device for Electric Stoves

(71) Applicant: Bryant Douglas Taylor, Smithfield, VA (US)

(72) Inventor: Bryant Douglas Taylor, Smithfield, VA (US)

(21) Appl. No.: 14/666,647

(22) Filed: Mar. 24, 2015

(51) Int. Cl. F24C 7/08; H04W 84/12

(52) U.S. Cl. CPC F24C 7/088; H04W 84/12

(57) ABSTRACT

A safety alert system that monitors the presence of electric current flowing into an electric cooking stove as to provide an alert or reminder to anyone in the vicinity that the stove is powered on. The alert system is composed of a stove power sensor that connects to the stove's power terminals and an alert device that plugs into a wall receptacle and has audible or visual alerts, the wherein the two are connected through radio frequency. When stove current is detected, the power sensor transmits a coded radio frequency signal to the alert device. The alert device produces an alert to indicate to anyone in the vicinity that the stove is on by an indicator. The alert device may indicate if the room light is turned off at night while the stove remains on and/or if the stove has been on for a long period of time.

### CROSS-REFERENCES TO RELATED APPLICATIONS

This application claims priority from provisional application 61/966,682 with a filing date of Mar. 4, 2014.

### FIELD OF THE INVENTION

This invention relates to safety devices used in electric cooking stoves and in particular to safety devices that alert someone that an electric cooking stove is on.

### BACKGROUND OF THE INVENTION

It is very easy for someone to leave an electric stove on after the cooking process has ended. A person can remove a pot from the stove top or remove baked goods from the oven and forget to turn the stove or oven off. In some cases, this condition is not noticed other than an increase in the utility bill or someone coming in contact with a hot stove top. In other cases, a fire could result if something is left cooking unattended on the stove top or in the oven. This problem is especially a concern for the elderly living alone. The inventor of this device has seen a documentary television program about a lady who had finished cleaning up in the kitchen and placed a dish towel on an electric stovetop surface that was set on low. Not knowing the stove was on because of the low setting; she turned off the kitchen lights and went to bed. Sometime during the night, the towel caught on fire and set the cabinets above the stove on fire. She woke up to the sound of her smoke detector and managed to get out of her smoked filled house to call the fire department at her neighbor's house. The fire department arrived in time to put the fire out before it spread throughout her house. Her house and life were saved, but there was fire and smoke damage in her kitchen. If she had had an effective alert system, she would have been alerted that the electric stove was still on when she turned off the kitchen lights. There have been occasions where elderly people living alone in a house or in an assisted living facility have left their electric stove on, leaving themselves vulnerable to a fire risk.

Therefore there is a need for an audible and visual alert as a reminder to anyone in or around the kitchen that the electric stove is on, and in particular when the lights are turned off indicating that the room is going to be unattended.

### SUMMARY OF THE INVENTION

This invention relates to a device that alerts anyone in the vicinity of an electric stove that the stove is on. The alert is in the form of a periodic audible sound, a visual flashing red light, and a continuous audible sound if the electric stove is on in a room with the lights off at night or if the stove has been left on over an amount of time.

Another embodiment of this invention is a device that can monitor the status of an electric stove and send this information to a computer or smart phone via the internet through a Wi-Fi connection.

An electric cooking stove monitoring system has an alert device adapted to be connected to a power supply, wherein the alert device is configured to provide an alert, and a power sensor in communication with the power supply of an electric stove; wherein the power sensor and the alert device are in communication by WI-Fi, and the power sensor transmits a signal to the alert device when electric current is flowing into the stove.

In an embodiment, the alert is a visual indicating light or a sound. In another embodiment the alert device comprises a light sensor configured to detect light, and the alert device provides an urgent alert when electric current is flowing into the stove and no light is detected by the light sensor.

In an embodiment, the alert device comprises an audible transducer capable of producing a sound level output of 100 decibels or higher. The alert device may have a radio frequency receiver, and the alert device may have a Wi-Fi transceiver and the power sensor may also have a Wi-Fi transceiver.

The alert device may flash an indicating light when electric stove heating element current is flowing, and/or produce a periodic audible sound when the electric stove in on. It may produce a continuous audible sound if the stove has been on for a preset amount of time.

The alert device and/or power sensor may have selectable switches to receive certain transmitting codes. The alert device may have selectable stove on times before an audible alarm is sounded.

The alert device and/or power sensor may have a microcontroller operating under a software program, and the power sensor may have an electromagnetic field sensor. Furthermore the power sensor may have an internal electromagnetic field sensor as to detect an electromagnetic field through the enclosure. The power sensor may have a radio frequency transmitter that transmits a digital code when an electromagnetic field is detected.

Another further embodiment of this invention is a device that can monitor the status of an electric stove and provide a means to turn the stove on or off by a computer or smart phone via the internet through a Wi-Fi connection.

### BRIEF DESCRIPTION OF THE DRAWINGS

FIG. 1 shows a front view of the alert device that plugs into a wall receptacle.

FIG. 2 shows a side view of the alert device that plugs into a wall receptacle.

FIG. 3 shows a back view of the alert device that plugs into a wall receptacle.

FIG. 4 shows a front view of the stove power sensor that connects to the power wires on an electric stove.

FIG. 5 shows a side view of the stove power sensor that connects to the power wires on an electric stove.

FIG. 6 shows a back view of the stove power sensor that connects to the power wires on an electric stove.

FIG. 7 shows a drawing how the stove power sensor connects to the power wires on an electric stove.

FIG. 8 shows a drawing how the shut off device connects to the power wires on an electric stove.

FIG. 9 shows a drawing of the front view of the adaptor plug for connecting a further embodiment of the invention to an electric stove.

FIG. 10 shows a drawing of the side view of the adaptor plug for connecting a further embodiment of the invention to an electric stove.

FIG. 11 shows a drawing of the back view of the adaptor plug for connecting a further embodiment of the invention to an electric stove.

### DETAILED DESCRIPTION

The present invention consists of a small electronic device that plugs into a kitchen wall receptacle above a counter top. This device sounds a short audible alert every twenty minutes or less when the electric stove in the kitchen is on. This short periodic alert would act as an audible reminder for anyone in or around the kitchen that the electric stove is in a cooking process. In addition to the short periodic audible alert, this invention also displays a flashing red light when the electric stove is on as a visual reminder for anyone in the kitchen or anyone entering the kitchen. Also, in addition to this periodic short audible alert, a continuous audible alert will sound if the electric stove is on and the kitchen lights are turned off at night. This would be a condition an electric stove should never be left on. The kitchen lights turned off at night is usually a condition that all activity in the kitchen is finished. Turning the kitchen lights off at night and not hearing an alarm would give someone going to bed peace of mind knowing that the electric stove has been turned off.

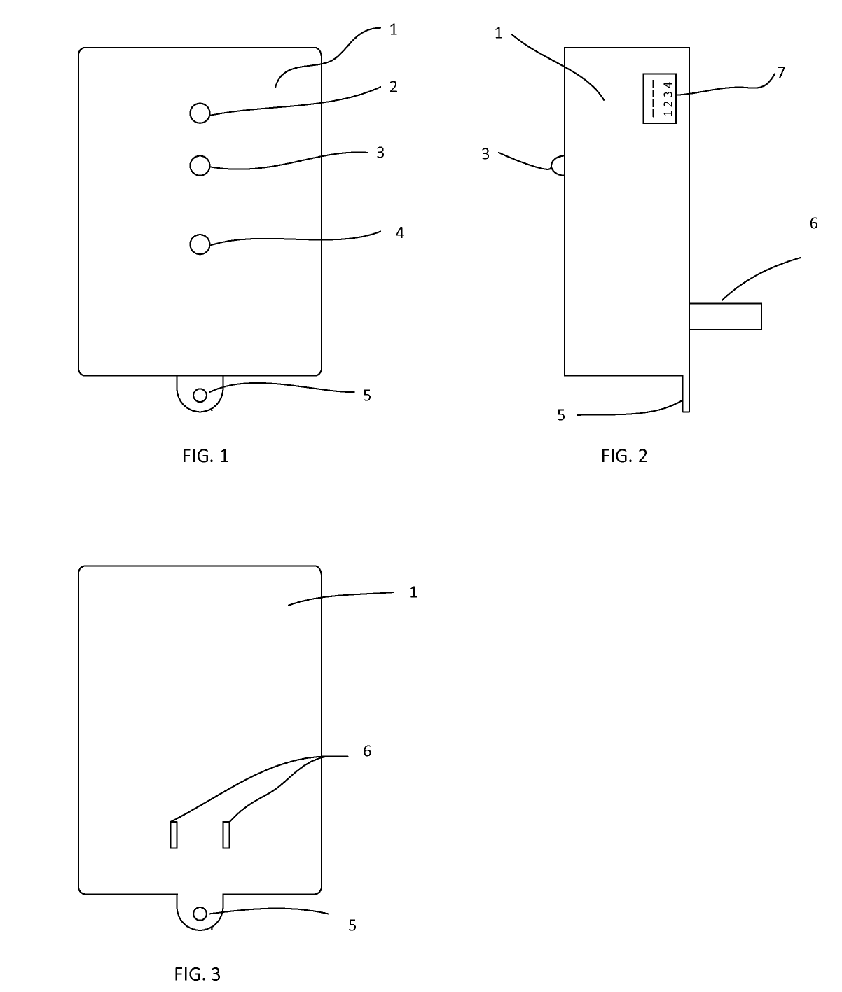

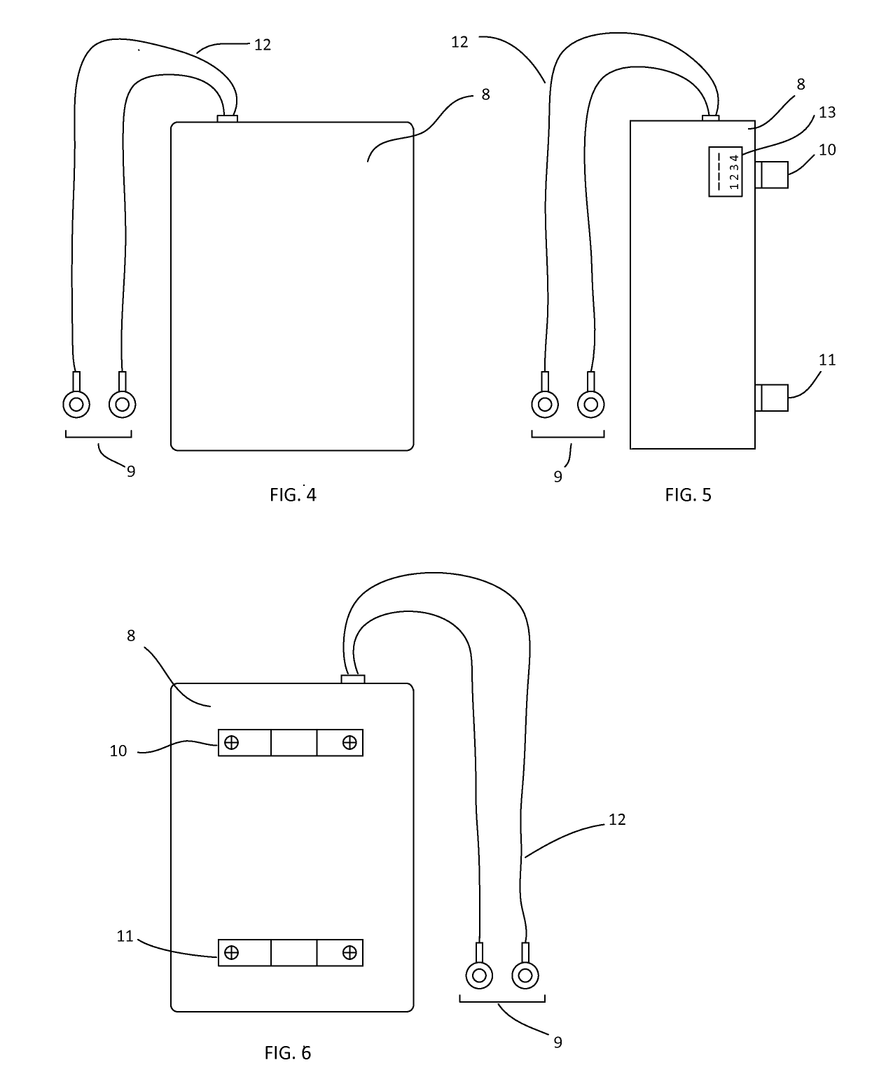

Referring now to the drawings and more particularly to FIG. 1 and FIG. 4. This invention is composed of two plastic electronic devices. Alert device 1 plugs into a wall receptacle above the counter top near an electric stove (not shown), or anywhere an alert may be broadcast, and stove power sensor 8 connects to the power terminals behind an electric stove.

Referring now to the drawings and more particularly to FIG. 1, FIG. 2, and FIG. 3 the alert device 1 that plugs into a wall receptacle. FIG. 1 is a drawing of the front of alert device 1 showing light sensor 2, red light emitting diode 3, audible beeper 4, and securing tab 5. In an embodiment, alert device 1 is so shaped as to be secured to the receptacle's wall plate by a screw going through the hole in tab 5. Light emitting diode 3 flashes every two seconds when electric current is flowing into the stove due to a heating element being energized. Light sensor 2 detects the light level in the room. An alarm condition will occur if the room is dark and electric current is flowing into the stove due to a heating element being energized. Audible beeper 4 allows sound pressure to exit from an electronic audible beeper inside alert device 1. Power for alert device 1 may be obtained by two AC prongs 6, or a DC battery or adapter, or other power sources known in the art. Dip switches 7 enable selection of different frequency receiving codes and the amount of time the stove has been on before an alarm condition will occur. In an embodiment, three of the dip switches 7 are reserved for receiving code selection and one dip switch is reserved for a the selection of the amount of time the stove has been on before an alarm condition will occur. Receiving code selection is provided because this invention uses radio frequency transmission to send information from power sensor 8 to the alert device 1. Having the feature of being able to select different codes prevents radio interference from other Safety Alert Devices operating in the vicinity such an in an apartment complex or an assisted living complex. The selection of the amount of time the stove has been on before an alarm condition will occur allows the selection of a time based on the user of the electric stove. For example, the custodian of an elderly person may select three hours because they know that person does not bake for long periods of time where as another custodian may select six hours because they know the user bakes for a period of time. The example of the time period selection of three hours or six or more hours can be any time that is decided when the invention is produced. Securing the alert device 1 to the wall plate by tab 5 prevents someone from quickly unplugging the alert device 1. Another embodiment of alert device 1 would be to add Wi-Fi circuitry so alert device 1 could connect to the internet to send alarm conditions to computers or smart phones.

Referring now to the drawings and more particularly to FIG. 4, FIG. 5, and FIG. 6 the stove power sensor 8 that connects to the power terminals on an electric stove. Power for stove power sensor 8 is obtained by connecting ring terminals 9 to the electrical power terminals supplying power to the stove. Wires 12 provide an electrical path from the ring terminals to the stove power sensor 8. In an embodiment heating element current is detected by sensing the magnetic field from one of the stove's power wires secured to stove power sensor 8 by wire clamps 10 and 11. An electromagnetic field sensor (not shown) inside device 8 under cable clamp 10 detects the magnetic field around the wire. The magnetic field passes through power sensor 8 to the magnetic field sensor inside power sensor 8. Stove power sensor 8 may be made of plastic as to allow a magnetic flux field to pass through. When a magnetic field is detected, stove power sensor 8 transmits a radio frequency signal via a small transmitter (not shown) inside stove power sensor 8 to alert device 1. Dip switches 13 select the transmitting code. The purpose of the dip switches 13 is explained above in the description of alert device 1. In an embodiment, the switch setting would be the same for alert device 1 and stove power sensor 8 except for the selection of the amount of time the stove has been on before an alarm condition will occur. This selection is set by one of the dip switches 7 on alert device 1 FIG. 2.

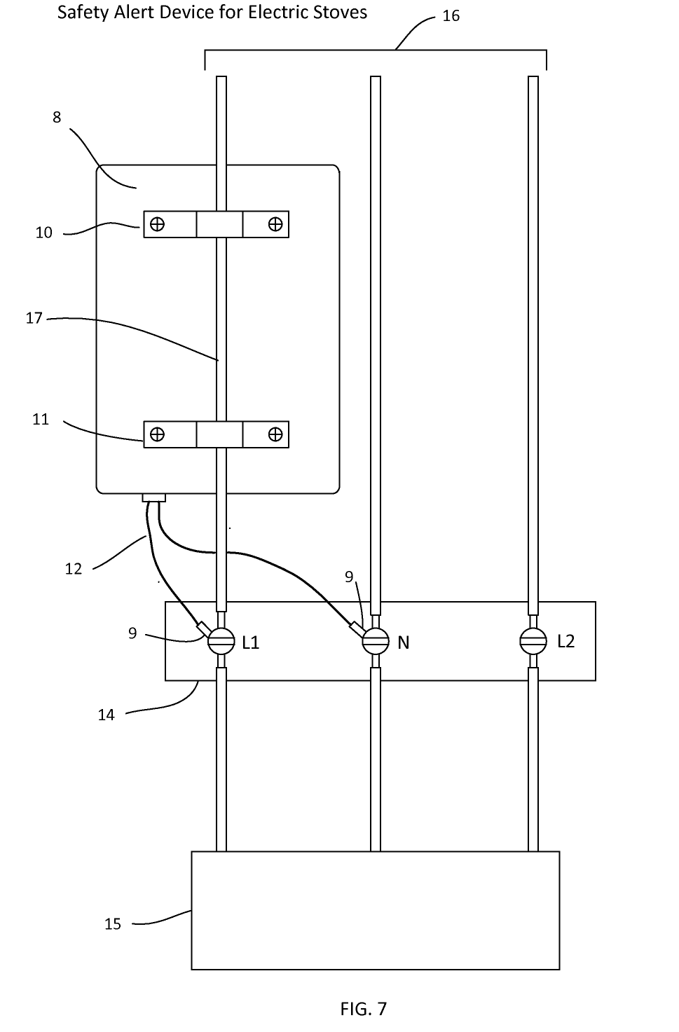

Referring now to FIG. 7, a drawing showing how the stove power sensor 8 connects to the power wires on an electric stove. Most electric stoves will have a terminal strip 14 where a power cord 15 is attached to supply 240 volts AC to the stove. Power for stove power sensor 8 is obtained by connecting ring terminals 9 to L1 and N or L1 and L2. The voltage between L1 and N is 120 volts AC and the voltage between L1 and L2 is 240 volts AC. Stove power sensor 8 is designed to operate on either 120 volts AC or 240 volts AC. This is to ensure stove power sensor 8 cannot be improperly connected. Stove power sensor 8 clamps onto any wire from terminal strip 14 to the internal connections 16 of the stove by wire clamps 10 and 11. Wire clamps 10 and 11 keep the wire 17 secure over the magnetic field sensor inside stove power sensor 8.

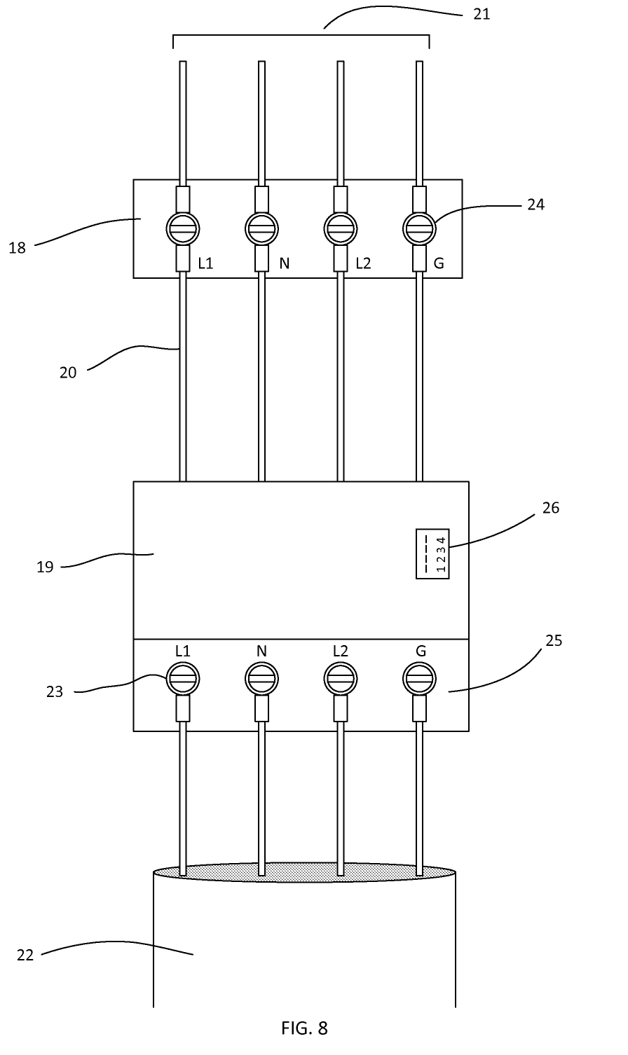

Referring now to FIG. 8, a drawing showing another embodiment of the invention that connects to the power wires on an electric stove. Shutoff device 19 is a plastic enclosure with electronic switches (not shown) inside capable of disconnecting power from the electric stove remotely by a computer or smart phone via a local Wi-Fi connection or through the internet. Shutoff device 19 is composed of a terminal strip 25, dip switches 26 and four short wires 20 with a ring terminal 24 at the end of each wire. Shutoff device 19 is installed in series with the stove's power terminal strip 18 and the stove's power cable 22. Installation consists of removing the power cord 22 from terminal strip 18 and connecting the power cord to device 19 terminal strip 25. Shutoff device 19 then connects to the stove's power terminal strip 18 by wires 20 with ring terminals 24. Terminal strip 18 connects to the stove's internal wiring 21. In an embodiment, shutoff device 19 transmits a radio frequency signal to alert device 1 when heating element current is flowing into the stove. Alert device 1 operates as described above when working with shutoff device 19. Shutoff device 19 has Wi-Fi capability so the status of the stove can be checked by a computer or smart phone through a Wi-Fi connection or via the internet. Furthermore, the stove may be turned off remotely with a computer or smart phone via the internet by operating the electronic switches (not shown). In an embodiment, one or more of the alert device, the shutoff device, and the adapter device have a Wi-Fi transceiver chip inside that connects to the Internet by a Wi-Fi router. An App may be downloaded to a smart phone or computer that would allow you to monitor the status of the stove by the alert device or the ability to turn the stove on or off by the shutoff device or the adapter plug.

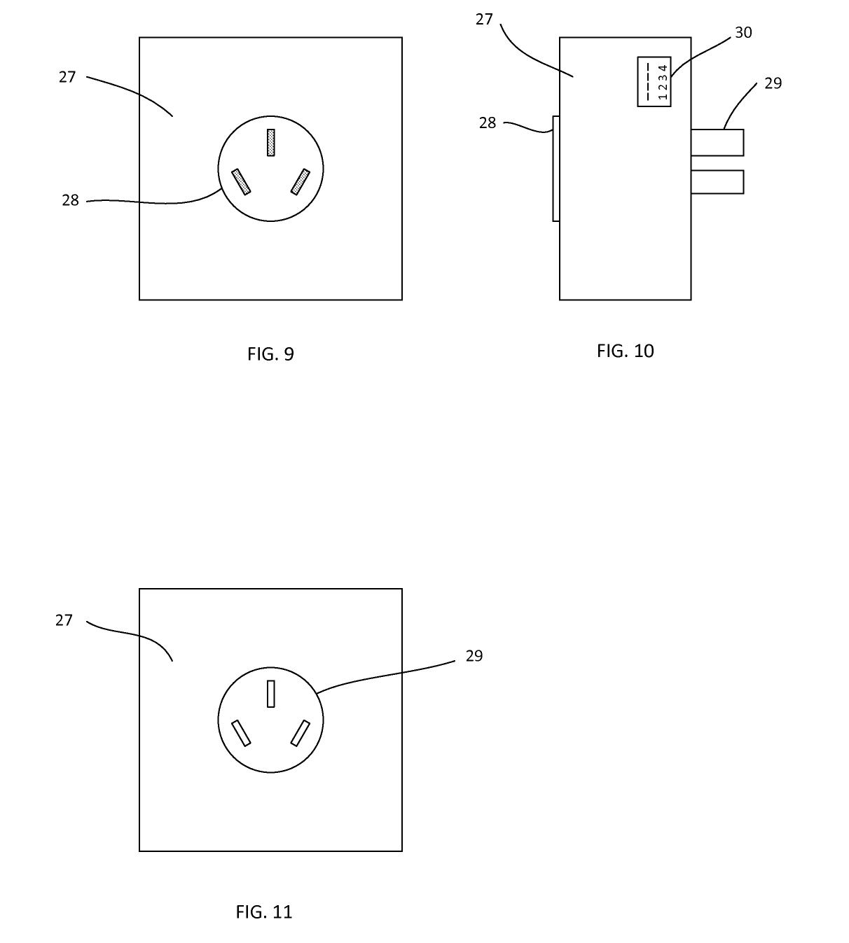

Referring now to the drawings and more particularly to FIG. 9, FIG. 10, and FIG. 11, a further embodiment of the invention is shown. FIG. 9 shows a drawing of the front view of an adapter plug 27 that is used to connect the heating element current sensing transmitter to a free standing electric stove. A free standing electric stove is a stove that can be slid away from the wall to gain access to the stove's power plug. Adapter plug 27 has a female receptacle 28 that accepts the stove's power plug (not shown). Adapter plug 27 as shown in the side view FIG. 10 has prongs 29 that plug into the power receptacle attached to the wall behind the free standing electric stove. Dip switches 30 select the transmitting code as explained above. FIG. 11 is a back view of adapter plug 27 showing the prongs 29. This drawing shows a three prong plug, but adapter plug 27 may have either three or four prongs, to match the plug of the stove. Electric stoves come in either three wire or four wire power plugs. The fourth wire is a frame ground connection on some stoves where as the ground connect to the neutral N on stoves with three wire plugs. Adapter plug 27 performs the same function as stove power sensor 8 except adapter plug 27 has electronic switches inside (not shown) capable of disconnecting power from the electric stove remotely by a computer or smart phone via a local Wi-Fi connection through the internet.

Adapter plug 27 is a more convenient way to connect the current sensing transmitter part this invention to a free standing stove. The disadvantage of the adapter plug 27 from a manufacturing point of view is that three wire and four wire adapters would have to be manufactured and not all electric stoves have a plug in power receptacle. For example, some drop in electric stoves are hard wired to a terminal box mounted to the floor under the stove.

One advantage of the current sensing transmitter of this invention as shown in stove power sensor 8 FIG. 4 is that stove power sensor 8 can connect to any three wire or four wire free standing or drop in electric stove.

The invention is a system that alerts anyone in the vicinity of an electric cooking stove that the stove is on or has been on for a length of time. The system is composed of two electronic devices. The alert device plugs into a wall receptacle above a kitchen counter top and the power sensor connects to the power source behind the kitchen stove. The power sensor detects when a heating element in the stove is energized and transmits a coded signal via a radio frequency transmitter to a radio frequency receiver inside the alert device. An energized heating element produces a magnetic field around one of the power wires going to the stove's internal wiring. This magnetic field is a product of electric current flowing through the wire. The power sensor detects this magnetic field by a sensor inside the device. A magnetic field is produced when any stove top burner or oven heating element is turned on. Once the stove is turned on, the alert device receives a signal from the power sensor device. Upon receiving this signal, the alert device provides a visual alert, such as a red light emitting diode blinking periodically. A periodic blinking, such as every two seconds, draws the attention of an individual better than a constant alert. The blinking light is a visual indicator to anyone in the kitchen that the stove is on. The light blinks whenever electric current is flowing into the stove due to a heating element being energized.

There are times when the alert device will not provide a visual alert even though the stove is on. This is because heating element current on most electric stoves is not continuous. To maintain the proper temperature, the power to the heating element cycles on and off. A microcontroller inside the alert device keeps track of this cycling power to control the time of the periodic beeper, the amount of time the stove has been on, and to determine that the stove is off. The oven heating element power can cycle off for as much a ten minutes for oven temperatures below 350 degrees Fahrenheit. If ten minutes has gone by without a heating element current signal received by the alert device, the alert device will reset indicating the stove is off and wait for a heating element energized signal from the stove power sensor to start a new timing sequence. In an example, the alert device could flash the red light continuously when heating element current is first detected, but the red light could continue to flash for up to ten minutes after the stove is turned off. For this reason, the light flashes only when heating element current is flowing. The flashing light will be more constant when a stove top burner is on because the power cycling time for stove top burners is much more frequent than oven heating element power on cycling times.

In an embodiment, the visual indicator is intermittent, and only indicates when electric current is flowing to the stove. However, in a preferred embodiment the aural indicator is periodic while electric current is detected; even it is detected only intermittently.

Aside from a visual indicator that the stove is on, in an embodiment, an audible beeper may be a possible alert. For example, it could sound two short beeps every twenty minutes as long as the stove is on. The two short beeps sounding every twenty minutes serve as a reminder to anyone in or close to the kitchen that the stove is on. The beeps are loud enough as to be heard in an adjacent room. For someone who is aware they have something cooking on the stove top or in the oven, the beeps every twenty keep them alert of the cooking process. For someone who has finished cooking, hearing the beeps alerts them that they have not turn the stove off.

If the kitchen lights are turned off at night and the kitchen is dark, and the stove is on, the alert device will provide a lights-out alert. In an embodiment, the alert device immediately starts emitting a series of beeps along with a flashing red light warning the person turning off the kitchen lights that the stove is still on. If the kitchen lights are turned off during the daytime and enough ambient light form the windows keeps the light sensor on the alert device from sensing a completely dark kitchen, the system will operate normally as if the kitchen lights were on at night.

If the stove has been on for six hours, the alert device will provide an overtime alarm. In an embodiment, it will sound two short beeps along with two short flashes from the red light emitting diode every two seconds when heating element current is flowing into the stove. A time of six hours or three hours may be selectable from one of the dip switches on the alert device. If the stove has been on long enough to activate this alarm condition, the stove needs to be turned off for ten minutes to reset the alert device.

Installation of this invention consist of setting the channel selection of the dip switches on the alert device 1 to the same channel selection of the dip switches on the stove power sensor 8. After the switches are set, the alert device 1 is plugged into a wall receptacle. In an embodiment, a short beep is heard about a second after the device is plugged into a wall receptacle indicating the device is ready.

Installation of the device that connects to the power source behind the kitchen stove consist of sliding the stove forward away from the wall to gain access to the stove's rear electrical panel cover. After pulling the stove away from the wall, unplug the stove's electrical power cord from the receptacle behind the stove before removing the screws that secure the stove's rear electrical panel cover. Using a screw driver, connect the ring terminals to the stove's electrical terminal L1 and N. Secure one of the wires from the electrical terminal to the stove's internal wiring to the power sensor 8 by opening the clamps and inserting the wire into the two wire clamps on the device and closing the clamps around the wire by tightening the wire clamp screws. There is no direct electrical connection from this wire to the power sensor 8. The wire clamps secure the wire over an electromagnetic field sensor inside the power sensor 8. Put the stove's electrical panel cover back on, plug the stove's power cord back into the receptacle, and slide the stove back against the wall. This completes the installation of the device that connects to the power source behind the kitchen stove. To test the installation, turn on any stove burner and observe the alert indicator on the alert device 1.

The dip switches on both devices are used to select different frequency channels. The ability to change channels would be needed if the alert device 1 is receiving a signal from another stove in the vicinity installed with the same transmitting frequency. This could occur in an apartment complex where other apartments above or below or across the hall have a stove with the same invention operating on the same channel. This would be evident if the red light flashes when the stove is off due to another safety alert device operating in the area on the same channel.

The alert device 1 can have the option of a Wi-Fi transceiver inside. This would give this invention the ability to wirelessly connect to a local Wi-Fi connection allowing alarm conditions to be sent to a computer at a nurse station at an assisted living facility. The status of the stove could also be checked by a computer or smart phone via the internet.

The stove power sensor 8 can have the option of a Wi-Fi transceiver inside along with the capability of being able to turn the power to the stove on or off via a computer or smart phone by means of an app. This would allow someone who has left their house the ability to check to see if they have turned off the stove. If they see that they have left the stove on, they would be able to turn off the stove with a smart phone or computer via the internet.

It is the intent of this disclosure to show different methods and devices for interfacing this invention to electric stoves. Although the invention has been described relative to a specific embodiment thereof, there are numerous variations and modifications that will be readily apparent to those skilled in the art in light of the above teachings. It is therefore to be understood that, within the scope of the appended claims, the invention may be practiced other than specifically described.

1. An electric cooking stove monitoring system comprising:
(a) an alert device adapted to be connected to a power supply, wherein the alert device is configured to provide an alert; and
(b) a power sensor in communication with the power supply of an electric stove; wherein the power sensor and the alert device are in communication by WI-Fi, and the power sensor transmits a signal to the alert device when electric current is flowing into the stove.

2. The monitoring system of claim 1 wherein the alert is a visual light.

3. The monitoring system of claim 2 wherein the alert device comprises a light source configured to produce a visual light.

4. The monitoring system of claim 1 wherein the alert device comprises a light sensor configured to detect light, and the alert device provides an urgent alert when electric current is flowing into the stove and no light is detected by the light sensor.

5. The monitoring system of claim 1 wherein the alert is a sound.

6. The monitoring system of claim 5 wherein the alert device comprises an audible transducer capable of producing a sound level output of 100 decibels or higher.

7. The monitoring system of claim 1 wherein the alert device comprises a radio frequency receiver.

8. The monitoring system of claim 1 wherein the alert device comprises a Wi-Fi transceiver and the power sensor comprises a Wi-Fi transceiver.

9. The monitoring system of claim 1 wherein the alert device flashes an indicating light when electric stove heating element current is flowing.

10. The monitoring system of claim 1 wherein the alert device produces a periodic audible sound when the electric stove in on.

11. The monitoring system of claim 1 wherein the alert device produces a continuous audible sound if the stove has been on for a preset amount of time.

12. The monitoring system of claim 1 wherein the alert device comprises selectable switches to receive certain transmitting codes.

13. The monitoring system of claim 1 wherein the power sensor comprises selectable switches to transmit certain transmitting codes.

14. The monitoring system of claim 1 wherein the alert device comprises selectable stove on times before an audible alarm is sounded.

15. The monitoring system of claim 1 wherein the alert device comprises a microcontroller operating under a software program.

16. The monitoring system of claim 1 wherein the power sensor comprises an electromagnetic field sensor.

17. The monitoring system of claim 1 wherein the power sensor comprises an internal electromagnetic field sensor as to detect an electromagnetic field through the enclosure.

18. The monitoring system of claim 1 wherein the power sensor comprises a radio frequency transmitter that transmits a digital code when an electromagnetic field is detected.

19. The monitoring system of claim 1 wherein the power sensor comprises a microcontroller operating under a software program.
